(19) United States
(12) Patent Application Publication
(10) Pub. No.: US 2010/0225455 A1
(43) Pub. Date: Sep. 9, 2010

(54) Polyphonic Doorbell Chime System

(76) Inventors: Jimmy David Claiborne, Scottsville, KY (US); Scott Blaise Tylicki, Bowling Green, KY (US)

Correspondence Address: FITCH EVEN TABIN & FLANNERY, 120 SOUTH LASALLE STREET, SUITE 1600, CHICAGO, IL, 60603-3406, US

(21) Appl. No.: 11/923,235

(22) Filed: Oct. 24, 2007

(51) Int. Cl. G08B 3/00

(52) U.S. Cl. 340/384.7

(57) ABSTRACT

A door chime system includes a microcontroller having a polyphonic MIDI music processor and a data memory for storing MIDI format sound files. The microcontroller includes an input for accepting signals from door chime actuators or pushbuttons and an output representative of distinct MIDI sound files.

### CROSS-REFERENCE TO RELATED APPLICATIONS

None.

### BACKGROUND OF THE INVENTION

1. Field of the Invention

The present invention relates generally to door chime systems and more specifically to a door chime system capable of reproducing polyphonic audio derived from a plurality of digital sound files stored in a data memory responsive to a plurality of user inputs and further capable of permitting operator selection from among a plurality of digital sound files stored in a polyphonic MIDI file format.

2. Description of the Related Art

Door chime systems utilizing a pushbutton to initiate the ringing of a chime or reproduction of a sound are well known. Many prior art systems employ a pushbutton or similar actuation device mounted proximate a door to activate an electrical circuit that converts electrical energy into mechanical energy to ring a chime or buzzer, or series thereof, thereby producing an audible signal that someone is at the door.

Furthermore, prior art systems have employed a speaker or speakers rather than electromechanically actuated chimes or other sound producing instruments to reproduce a pre-recorded sound or series of sounds, often responsive to a simple analog electrical signal produced by suitable circuitry upon the actuation of the doorbell pushbutton. Some of these systems offer the advantage of permitting a user to select from a plurality of sounds or tones to be used as a door chime, thereby permitting a certain level of customization of chime sounds, as predetermined by the device manufacturers.

Other prior art door chime systems employ circuitry that permits the system to play a first prerecorded sound responsive to a first doorbell pushbutton, and a second prerecorded sound responsive to a second doorbell pushbutton in order to enable an occupant to distinguish whether a caller is at one of two doors. Furthermore, some sophisticated doorbell systems are available that enable a user to pre-select a digitally encoded sound, or portions thereof, from a list of a plurality of stored sounds for use as a chime.

However, all of the prior art door chime systems discuss herein above are difficult or impossible to customize, unwieldy to use, and limited in their ability to reproduce complex polyphonic sounds. Additionally, the more sophisticated of these systems are quite complex and thus expensive to manufacture and install.

### SUMMARY OF THE INVENTION

A sound synthesizer format in which a library of sounds is maintained in a sound producing arrangement and a sound generating controller receives directions from a sound file with instructions to identify how the sounds from the library should be combined to produce an overall sound passage. The library of sounds may also include pre-stored instructions concerning how, or by what instrument, the sounds in the file are to be reproduced. For example, data representing various notes of the musical scale may be stored in the sound library along with data describing how the notes are to be reproduced to emulate a piano, organ or flute. A sound file can then be applied to the sound controller which specifies flute sound can be reproduced from the sound library. While sound libraries and complex sound construction controllers do add costs, the reduction in size of the sound files in the sound synthesizer format significantly offset those costs. The most common sound synthesizer format presently in use is the MIDI format although others such as IMF and CMF exist.

The disadvantages of the prior art are overcome by the door chime system of the present invention which comprises an electronic door chime system including a circuit having a means for storing a plurality of sound files therein, and a user interface that permits the selection of a specified sound file, or a portion thereof, to be converted to sound responsive to the actuation of a door bell or other chime actuation means. In a preferred embodiment this sound file is in the MIDI format.

One embodiment of the present invention provides a doorbell system having a housing or enclosure in which is contained a circuit for providing polyphonic audio responsive to the actuation of a doorbell pushbutton, or a plurality of doorbell pushbuttons. The circuit provided herein includes a plurality of terminals for securing electrical connections between a plurality of doorbell pushbuttons, switches, or any form of signal and the circuit, and further comprises an integrated circuit having concomitant data memory for storing a plurality of polyphonic audio files.

The integrated circuit comprises a controller having an input or inputs able to detect the actuation of at least one doorbell pushbutton to initiate playback of the stored sound file. Many types of controllers may be used such as application specific integrated circuit, a customized integrated circuit, a microprocessor or any other control technology. In a preferred embodiment the controller is based on a programmed microcontroller.

The invention may include a selector switch having multiple switch positions that enables the selection of a specific sound file to be converted to sound upon doorbell pushbutton actuation. The selector switch, or a plurality thereof, may be configured for the number of sound files to be selected.

A system in accordance with the invention may further include a speaker for producing the sound from the signals produced from the controller. In some embodiment an audio amplifier may be employed to increase the amount of volume produced from the speaker.

The present invention permits a user to download sound files, for example files saved utilizing the polyphonic MIDI file format, into a data storage memory and select a specific file to be converted to sound or played when the door chime is actuated. MIDI files are a preferred file format due to the relatively smaller size and accessibility. MIDI files can be one tenth the storage requirement of the equivalent MP3 file. MIDI files can be downloaded through devices such as memory cards, flash drives, PCs, PDAs or others. Additional options for downloading may include wireless transfer or downloading from the Internet or other networks. Furthermore, the system disclosed herein will permit an additional level of customization by allowing a user to select a plurality of different sounds to be reproduced upon actuation of a plurality of different door chime pushbuttons or switches, thereby permitting a user to know which pushbutton has been depressed by the polyphonic sound being reproduced. This feature of the invention is particularly useful where the system is installed at a site having multiple locations for ingress and egress, for example a business or a large residential dwelling.

Other objects, features, and advantages of the present invention will become apparent from the detailed description of the preferred embodiments, taken in conjunction with the drawing Figures as described herein below.

### BRIEF DESCRIPTION OF THE DRAWING FIGURES

FIG. 1 is a circuit diagram of a door chime system in accordance with one embodiment of the present invention;

FIG. 2 is a circuit diagram of a door chime system in accordance with one embodiment of the present invention;

FIG. 3 is a circuit diagram of a door chime system in accordance with one embodiment of the present invention;

FIG. 4 is circuit diagram of a door chime system in accordance with one embodiment of the present invention;

FIG. 5 is a perspective view of an enclosure in accordance with one embodiment of the present invention;

FIG. 6 is a perspective view of an enclosure in accordance with one embodiment of the present invention.

### DETAILED DESCRIPTION OF THE PREFERRED EMBODIMENT(S)

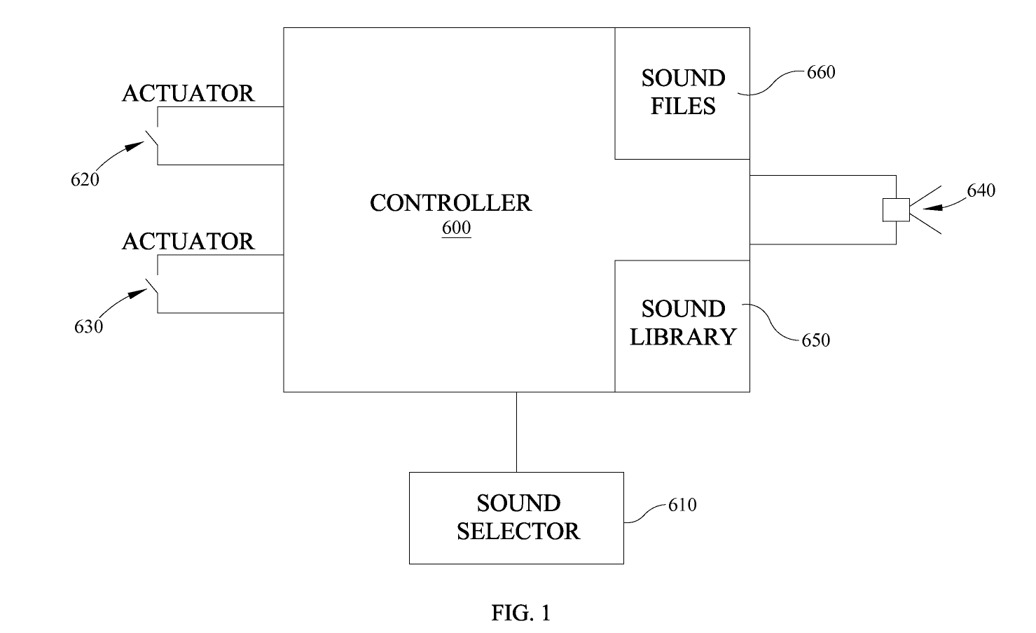

Referring to FIG. 1 and in accordance with one embodiment of the present invention, a door chime system 10 comprises a controller 600, connected to controller 600 is a sound selector 610, actuator 620, actuator 630, and speaker 640. A sound library 650 can be included in the controller or be a external library connected to the controller. Sound files 660 can be included in the controller or be a external files connected to the controller. When actuator 620 is actuated controller 600 reads the sound selector 610 and selects at least one sound file to reproduce from the sound files 660. The controller selects the sounds and how to produce them from the sound library 650 according to instruction from the sound file. These sounds are reproduced by speaker 640.

When actuator 630 is actuated controller 600 reads the sound selector 610 and selects at least one sound file to reproduce from the sound files 660. The controller selects sounds and how to produce them from the sound library 650 according to instruction from the sound file. These sounds are reproduced by speaker 640. In a preferred embodiment the selection of the file to reproduce when actuator 630 is actuated is different then when actuator 620 is actuated.

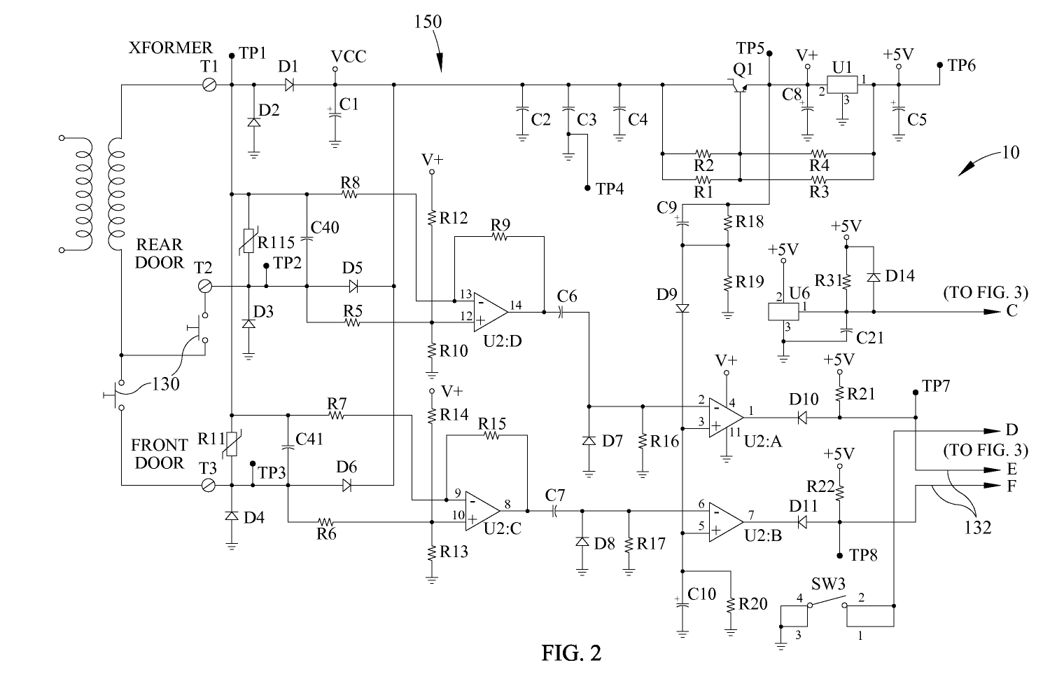

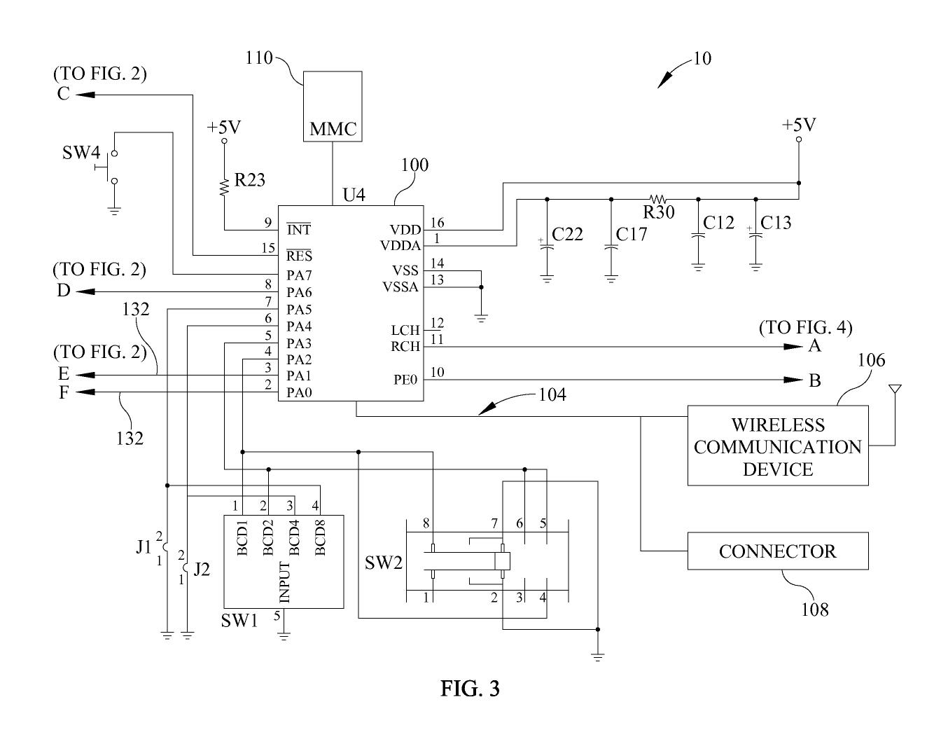

Referring now to drawing FIGS. 2-4, and in accordance with one embodiment of the present invention, a door chime system 10 comprises a controller 100, shown in FIG. 3 as microprocessor U4, having a plurality of inputs for receiving a plurality of door bell pushbutton 130 outputs 132. While the term “pushbutton” will be used throughout this specification to denote a device capable of initiating door chime actuation, one of ordinary skill in the art will understand that the pushbutton may be replaced with a wide variety of equivalent switches or actuators responsive to a positive act from a visitor, or alternatively, responsive to the presence of a visitor at a predetermined location whereby a sensor detects the visitor's presence and actuates the door chime system 10.

The microcontroller 100 further includes an associated data memory 110 and an analog output at pins RCH and LCH (or a plurality thereof) for supplying a polyphonic audio signal to a sound reproduction system, as discussed further herein below. The data memory 110 may be integral to microcontroller 100 or may be incorporated as a separate memory card, for example a flash memory card such as one of many known in the art multi-media cards (MMC's). The use of a removable memory card enables quick and simple customization of sounds, as will be discussed further below.

The microcontroller 100 also comprises a communications port 104, for example a MIDI port and associated connector, thereby permitting communications with a plurality of peripheral devices for downloading polyphonic MIDI sound files or other digital sound files incorporating alternative digital formats for eventual playback. Port 104 is shown in FIG. 3 as connected to a connector 108 to which a user can connect an audio data source to download sound representations form a device such as a personal computer, PDA, or cellular telephone. Optionally port 104 may be connected to a wireless communication device 106 which is shown in FIG. 3 in a dashed line box. This wireless communication can be Wifi (802.11), IrDA, Zigbee, Bluetooth, WiMax or any other open or proprietary system to allow the transfer from the audio data source to the communication port. When a new sound file is to be received from a user it is connected from 106 or 108 to the port 104. Microcontroller 100 then receives the sound file at port 104, and properly loads the file into memory 110 and optionally records the new file directory for later selection.

The microcontroller 100 of the present invention may further comprise one of many commercially available sound microprocessors U4, for example an 8 bit music synthesizer control unit that is capable of providing an polyphonic output signal representative of a stored MIDI file.

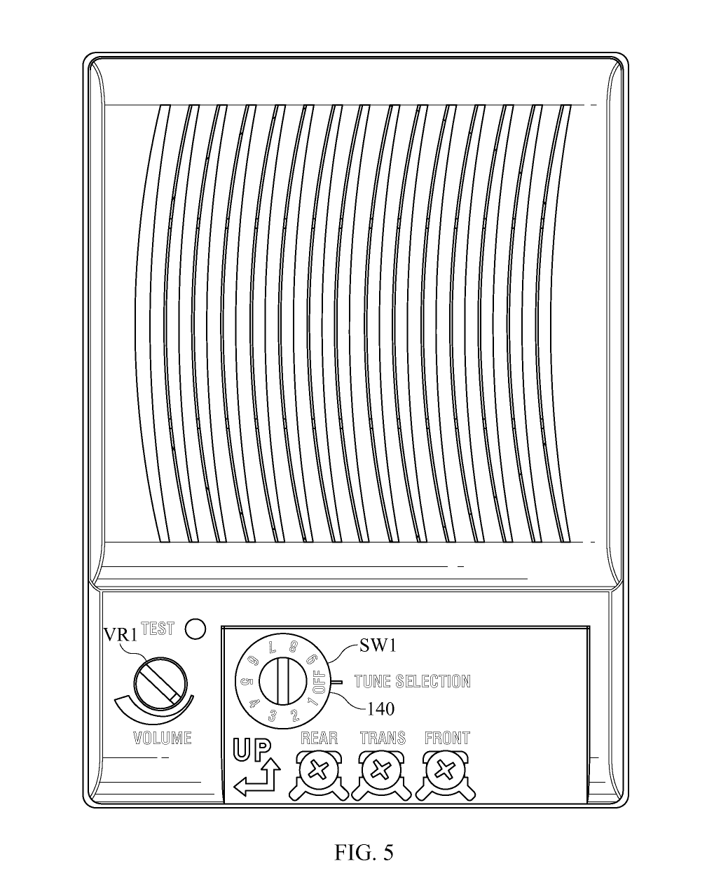

Referring to FIG. 3, a user interface 140 is operatively connected to the microcontroller 100 to permit various features of the system 10 to be configured, as will be discussed in greater detail below. User interface 140 is depicted here as an enclosure that contains the components of system 10 and enables installation thereof in a compact easily mounted package. In one embodiment of the present invention the user interface 140 comprises a selector switch SW1 for selecting audio files to be converted to sound responsive to doorbell actuation as well as a volume control adjustment potentiometer VR1. While selector switch SW1 is depicted in FIG. 5 as a rotary switch to enable a user to select from a plurality of audio files to be converted to sound, it will be recognized that a variety of equivalent selection devices such as pushbutton switches or operator interfaces including but not limited to personal computers or LCD touch screens can be used to enable audio file selection without departing from the scope of the present invention.

The user interface 140 enables a user to select from a plurality of chime sounds stored in data memory 110 to be played responsive to a doorbell pushbutton 130.

In a further embodiment of the invention, a separate polyphonic MIDI music processor may be employed to communicate with microcontroller 100 wherein the polyphonic MIDI audio processor provides an audio output representative of a polyphonic MIDI sound file responsive to an input from microcontroller 100, indicating that a pushbutton 130 has been actuated. In this embodiment of the invention, the input signal from microcontroller 100 to the polyphonic MIDI music processor may be indicative of which of a plurality of doorbell pushbuttons 130 has been actuated, thereby enabling the converted to sound of a specific sound file for each pushbutton 130.

Referring now to the embodiment of the invention as seen in FIG. 3, selector switch SW1 may comprise a 4 position binary coded decimal (BCD) output switch that permits a user to select from among 16 different chime sounds by activating a combination of binary outputs BCD1, BCD2, BCD4 and BCD8 which represent the first four places in a binary number system. The BCD outputs are coupled to pins PA2, PA3, PA4, and PA5 of microcontroller U4. When a user selects a switch position for SW1, the binary outputs BCD1, 2, 4 and 8 are set to correspond to the numbers 0-15, thereby enabling microcontroller U4 to determine which audio file the user wishes to be converted to sound responsive to doorbell actuation. In one embodiment of the invention SW1 is assigned to correspond to an audio sound set to be played upon actuation of a front or main doorbell.

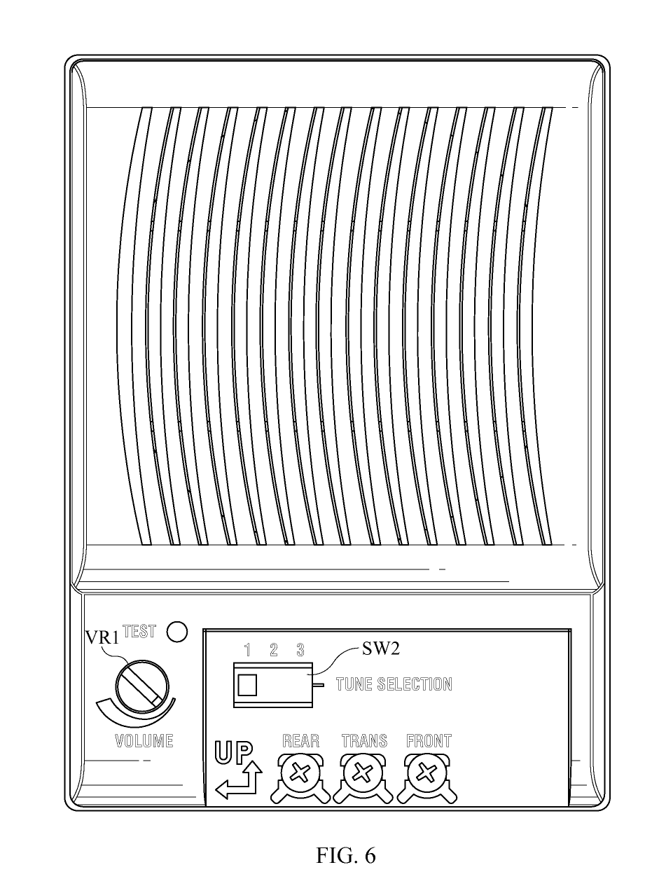

Referring again to FIGS. 3 and 6, and in accordance with an alternative embodiment of the invention, optional switch SW2 is depicted as a three position slide-switch operatively coupled to input pins PA2 and PA3 of microcontroller U4. When switch SW2 is employed in the system 10 of the present invention jumpers J1 and J2, normally not present in system 10, may be installed to ground outputs BCD4 and BCD8 of switch SW1. Accordingly, jumpers J2 and J1 enable a user to ground (or not ground) input pins PA4 and PA5, respectively, thereby enabling selection of 4 different sets of polyphonic audio files since four combinations of settings for jumpers J1 and J2 and thus pins PA4 and PA5 are possible.

Switch SW2 then provides 3 different positions and thus discrete signal inputs to microcontroller U4, which indicates to microcontroller U4 that a specific sound of the sound set is being chosen. Thus switch SW2 selects a specific sound to be played responsive to doorbell actuation from a set of sounds chosen by the position of jumpers J1 and J2. SW2, while shown as a three position switch, may comprise one of many known switches without departing from the scope of the invention.

Referring again to FIGS. 2 and 3, switch SW3 is operatively coupled to input pin PA6 of microcontroller U4. When closed, switch SW3 operates as a test switch to provide an input to microcontroller U4 that instructs it to play the sound file that is selected for the front door chime actuator so that the sound can be heard without actuating a pushbutton as a test mechanism.

Referring now to FIG. 2, and in accordance with one embodiment of the invention, a detector circuit 150 provides an electrical signal output of predetermined magnitude and duration responsive to the depression of pushbutton 130. Detector circuit 150 may be used wherein a momentary depression of a pushbutton 130 provides an insufficient electrical signal to initiate audio file playback. A front door pushbutton 130 is connected between terminals T3 and T1, whereas a rear door pushbutton 130 is connected between terminals T2 and T1. Front doorbell pushbutton 130 is electrically coupled to input terminal PA0 of microcontroller U4 through op amps U2:C and U2:B, which provide amplification and noise filtration to the doorbell signal. Similarly, rear doorbell pushbutton 130 is electrically coupled to input terminal PA1 of microcontroller U4 through op amps U2:D and U2:A, thereby providing an indication of rear doorbell actuation to microcontroller U4.

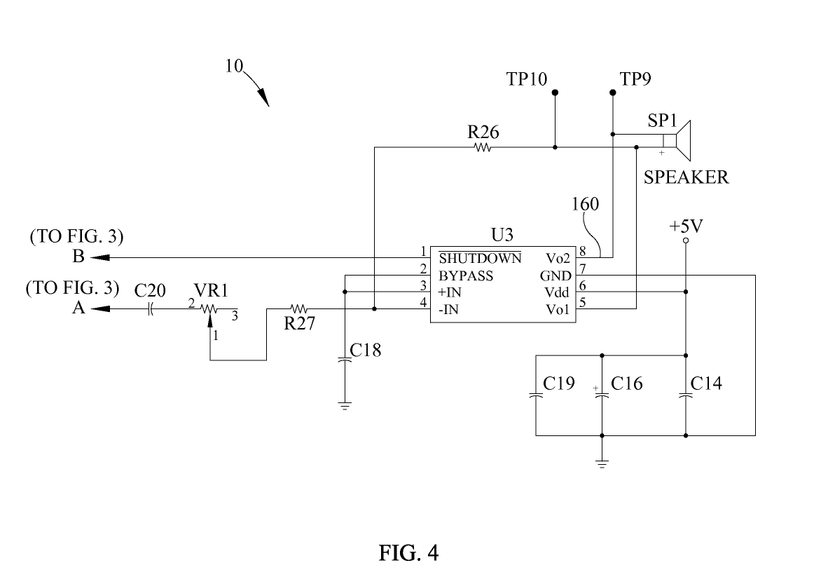

Referring to FIGS. 3 and 4 microcontroller U4 includes an output RCH (or LCH) that is an analog audio output electrically coupled to an amplifier integrated circuit U3 input pin (−IN). Amplifier U3 provides an audio output signal 160 to speaker SP1 to converted to sound the selected audio sound. Since microcontroller U4 is capable of providing an analog output representative of a polyphonic MIDI format file, further signal processing with its attendant cost and complexity is unnecessary. A rheostat, VR1, is provided to enable a user to adjust the sound volume by varying the level of analog signal RCH and/or LCH supplied to amplifier input (−IN).

In operation, when front doorbell pushbutton 130 is depressed, pushbutton output 132 provides an electrical signal to input PA0 of microcontroller 100 to initiate door chime playback. Where multiple pushbuttons 130 are installed, another output 132 is electrically connected to input PA1 of microcontroller 100 so that the system 10 can distinguish which doorbell pushbutton 130 has been depressed, based upon the signals provided at inputs PA0 and PA1. A user may select, via the operator interface 140 and switch SW1 (or alternatively switch SW2) a sound stored in data memory 110 to be played back responsive to the depression of a specific pushbutton 130. Switch SW3 can then be depressed or closed to play the selected sound. While this embodiment shows the pushbuttons wired to the door chime for clarity the pushbuttons can also be operably coupled to the door chime through wireless methods. The pushbuttons can have a different wireless signal to identify which of the multiple pushbuttons have been activated. These methods are well understood in the industry.

When the front doorbell pushbutton input PA0 is detected, microcontroller U4 selects the audio file indicated by switch SW1 (or alternatively by the combination of switches SW1 and SW2 as discussed herein above) and produces a polyphonic analog audio output on pin RCH which is amplified through amplifier IC U3, then reproduced via speaker SP1 and/or SP2.

In a like manner, switch SW4 selects from two specific polyphonic sound files by providing a binary input to pin PA7. Accordingly, when the rear doorbell pushbutton input PA1 is detected by microcontroller U4 it produces an analog audio output responsive thereto on pin RCH and/or LCH which is amplified through amplifier IC U3, then reproduced via speakers SP1 and/or SP2 as desired.

Additionally, since microprocessor U4 is capable of storing and playing MIDI format files, different sound file sets may be downloaded to microcontroller U4 through port 104 to enable a user to customize and update the sounds played through system 10. Additionally, the sound files may simply be switched out by removing a flash data memory card 110 from system 10, and inserting another having a different sound file set stored thereon. This feature of the present invention provides a user the ability to quickly and efficiently customize the audio of system 10 with minimal expertise and effort required.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

1. A door chime system comprising:
a doorbell actuator configured to be mounted proximate to an access point;
a sound transducer configured to provide sound in an area opposite of the access point of the doorbell actuator; and
a controller operatively connected to the actuator and sound transducer, the controller configured to in response to actuation of the actuator:
retrieve a plurality of data files representing a plurality of sounds;
convert the plurality of data files into a polyphonic audio signal comprising the plurality of sounds; and
send the audio signal to the sound transducer, the sound transducer configured to output the polyphonic audio signal to audibly indicate actuation of the actuator.

2. The door chime system as is claimed in claim 1 further comprising a storage device operatively connected to the controller and configured to store the plurality of data files therein.

3. The door chime system as is claimed in claim 2 wherein said actuator is one of multiple actuators.

4. The door chime system as is claimed in claim 3 wherein the storage device is further configured to store instructions comprising which of the plurality of data files the controller retrieves in response to actuation of respective actuators of said multiple actuators.

5. The door chime system as is claimed in claim 3 wherein the controller is configured to retrieve the plurality of data files in response to at least one selector.

6. The door chime system as is claimed in claim 5 wherein the storage device is further configured to store instructions comprising which of the plurality of data files the controller retrieves in response to actuation of respective actuators of said multiple actuators and the at least one selector.

7. The door chime system as is claimed in claim 1 further comprising a polyphonic audio synthesizer sound file source and an apparatus configured to receive a polyphonic audio synthesizer sound file from a polyphonic audio synthesizer sound file source.

8. The door chime system as is claimed in claim 1 further comprising a receiver configured to wirelessly receive the plurality of data files.

9. The door chime system as is claimed in claim 8 wherein the receiver is configured to receive the plurality of data files over at least one wireless transfer method selected from the group consisting of Wifi (802.11), IrDA, Z-Wave, Zigbee, Bluetooth, and WiMax.

10. The door chime system as is claimed in claim 2 wherein the storage device is removable.

11. A door chime system comprising:
a controller configured to retrieve a plurality of polyphonic musical instrument digital interface (MIDI) sound files and combine sound files of the plurality of polyphonic MIDI sound files into an audio output representative of said sound files;
at least one doorbell actuator mounted proximate to an access point and operatively coupled to said controller, the actuator configured to initiate output of the audio output to audibly indicate actuation of the actuator.

12. The door chime system as is claimed in claim 11 further comprising a storage device operatively coupled to the controller and configured to store the plurality of polyphonic MIDI sound files.

13. The door chime system as is claimed in claim 12 wherein said at least one actuator is at least two actuators.

14. The door chime system as is claimed in claim 13 wherein the controller is configured to retrieve the sound files according to which of the at least two actuators was actuated.

15. The door chime system as is claimed in claim 12 wherein the controller is configured to retrieve the sound files according to at least one selector.

16. The door chime system as is claimed in claim 13 wherein the controller is configured to retrieve the sound files according to at least one selector and which of the at least two actuators was actuated.

17. The door chime system as is claimed in claim 11 wherein said plurality of polyphonic MIDI sound files are file are transferable from a polyphonic MIDI sound file source.

18. The door chime system as is claimed in claim 17 wherein said polyphonic MIDI sound files are transferred wirelessly.

19. The door chime system as is claimed in claim 18 wherein the wireless transfer method is selected from the group consisting of Wifi (802.11), IrDA, Z-Wave, Zigbee, Bluetooth, and WiMax.

20. The door chime system as is claimed in claim 11 wherein said polyphonic MIDI sound files are stored on a removable memory.

21. A door chime system comprising:
a controller having a polyphonic musical instrument digital interface (MIDI) music processor, a data memory associated therewith configured to store a plurality of polyphonic MIDI sound files, and at least one output with the ability to produce audio output representative of at least two polyphonic MIDI sound files;
a plurality of doorbell buttons configured to be mounted proximate to individual of access points and operatively coupled to said controller, the plurality of doorbell buttons configured to initiate the production of audio output on the at least one output in response to actuation;
wherein the audio output is responsive to which of the plurality doorbell buttons is actuated.

22. A door chime system as claimed in claim 21 further comprising an operator interface configured to receive instructions identifying sound files for audio output for respective doorbell buttons of each of said plurality of doorbell buttons.

23. A door chime system as claimed in claim 21 wherein said data memory comprises a removable memory card.

24. A door chime system as claimed in claim 21 further comprising:
a port operatively connected to said controller for downloading polyphonic MIDI files to said data memory from remote storage.

25. A door chime as in claim 24 wherein said port communicates with said remote storage device via a wireless communication interface selected from the group consisting of Wifi (802.11), IrDA, Z-Wave, Zigbee, Bluetooth, and WiMax.
